(19) United States
(12) Patent Application Publication
(10) Pub. No.: US 2026/0368606 A1
(43) Pub. Date: Nov. 19, 2026

(54) PARALLEL PREPARATION OF MAGIC STATES ON QUANTUM ERROR-CORRECTING CODES

(71) Applicant: INTERNATIONAL BUSINESS MACHINES CORPORATION, ARMONK, NY (US)

(72) Inventors: Edward Hong Chen, Apex, NC (US); Patrick Julian Tassilo Rall, Boston, MA (US); Andrew W. Cross, Yorktown Heights, NY (US); Theodore James Yoder, Mohegan Lake, NY (US)

(21) Appl. No.: 19/210,189

(22) Filed: May 16, 2025

(51) Int. Cl. G06N 10/70; G06N 10/20; G06N 10/40

(52) U.S. Cl. CPC G06N 10/70; G06N 10/20; G06N 10/40

(57) ABSTRACT

One or more computer processors determining a subset of corner qubits within a plurality of identified logical operators comprised within quantum error correction (QEC) code. The one or more computer processors iterate through each qubit in the first logical support to determine a first set of qubits from the first logical support that overlap with a third logical support by iterating through each qubit in the first logical support; iterate through each qubit in the second logical support to determine a second set of qubits from the second logical support that overlap with a fourth logical support; generate a graph with the first set of qubits and the second set of qubits; identify one or more stabilizer states utilizing the generated graph; and derive a quantum circuit with the one or more stabilizer states and the subset of corner qubits.

### BACKGROUND

The invention relates generally to the field of quantum computing, and more particularly to quantum error-correcting.

Quantum error correction (QEC) is a set of techniques used in quantum computing to protect quantum information from errors due to decoherence and other quantum noise. Quantum error correction is theorized as essential to achieve fault tolerant quantum computing that can reduce the effects of noise on stored quantum information, faulty quantum gates, faulty quantum state preparation, and faulty measurements. Effective quantum error correction allows quantum computers with low qubit fidelity to execute algorithms of higher complexity or greater circuit depth.

Low-density parity-check (LDPC) codes are a class of error correction codes which are widely used in applications ranging from wireless communications to flash-memory storage. Central to the performance of LDPC codes is their adaptability to the iterative belief propagation decoding algorithm. LDPC codes focus on sequences of codes of fixed code rate and increasing block length. These sequences are typically tailored to a set of channels. For appropriately designed sequences, the decoding error under belief propagation can often be proven to approach zero with the block length at rates that are very close to the capacities of the channels.

### SUMMARY

Embodiments of the invention disclose a computer-implemented method, a computer program product, and a system. The computer-implemented method includes one or more computer processers determining a subset of corner qubits within a plurality of identified logical operators comprised within quantum error correction (QEC) code, wherein one or more corner qubits in the subset of corner qubits originate from an intersection of a first logical support and a second logical support. The one or more computer processors iterate through each qubit in the first logical support to determine a first set of qubits from the first logical support that overlap with a third logical support by iterating through each qubit in the first logical support. The one or more computer processors iterate through each qubit in the second logical support to determine a second set of qubits from the second logical support that overlap with a fourth logical support. The one or more computer processors generate a graph with the first set of qubits and the second set of qubits. The one or more computer processors identify one or more stabilizer states utilizing the generated graph. The one or more computer processors derive a quantum circuit with the one or more stabilizer states and the subset of corner qubits.

### BRIEF DESCRIPTION OF THE DRAWINGS

Figure (i.e., FIG.) 1 is a functional block diagram illustrating a computing environment, in accordance with an embodiment of the invention;

FIG. 2A is a functional block diagram illustrating a hybrid computing environment, in accordance with an embodiment of the invention;

FIG. 2B is a functional block diagram further illustrating the hybrid computing environment, in accordance with an embodiment of the invention;

FIG. 3 is a flowchart depicting operational steps of a program, on a computer within the environments of FIGS. 1, 2A, or 2B, for parallel preparation of magic states on quantum error correction codes, in accordance with an embodiment of the invention;

FIG. 4A is an example illustration of operational steps of the program within the environments of FIGS. 1, 2A, or 2B, in accordance with an embodiment of the invention;

FIG. 4B is an example illustration of operational steps of the program within the environments of FIGS. 1, 2A, or 2B, in accordance with an embodiment of the invention;

FIG. 4C is an example illustration of operational steps of the program within the environments of FIGS. 1, 2A, or 2B, in accordance with an embodiment of the invention;

FIG. 5 is an example illustration of operational steps of the program within the environments of FIGS. 1, 2A, or 2B, in accordance with an embodiment of the invention;

FIG. 6 is an example graph of operational steps of the program within the environments of FIGS. 1, 2A, or 2B, in accordance with an embodiment of the invention; and

FIG. 7 is an example illustration of operational steps of the program within the environments of FIGS. 1, 2A, or 2B, in accordance with an embodiment of the invention.

### DETAILED DESCRIPTION

According to an aspect of the invention, there is a provided method, computer system, and computer program product to determine a subset of corner qubits within a plurality of identified logical operators comprised within quantum error correction (QEC) code, wherein one or more corner qubits in the subset of corner qubits originate from an intersection of a first logical support and a second logical support; iterate through each qubit in the first logical support to determine a first set of qubits from the first logical support that overlap with a third logical support by iterating through each qubit in the first logical support; iterate through each qubit in the second logical support to determine a second set of qubits from the second logical support that overlap with a fourth logical support; generate a graph with the first set of qubits and the second set of qubits; identify one or more stabilizer states utilizing the generated graph; and derive a quantum circuit with the one or more stabilizer states and the subset of corner qubits. The entire aspect of the invention, detailed above, might cause improved utilization and efficiency of quantum computing by parallel preparation of magic states.

According to an aspect of the invention, the provided method, computer system, and computer program product may further comprise removing repeated corner qubits. In embodiments, the removing repeated corner qubits, at least, advantageously increases the efficiency and utilization of a quantum computing system.

According to an aspect of the invention, the provided computer-implemented method, computer system, and computer program product may further comprise the QEC code is low-density parity-check code. In embodiments, the quantum error correction code is low-density parity-check code, at least, advantageously improves the resource utilization in quantum processing.

According to an aspect of the invention, the provided computer-implemented method, computer system, and computer program product may further comprise the generated graph has nodes that are physical qubits and edges representing overlapping logical pairs. In embodiments, the generated graph has nodes that are physical qubits and edges representing overlapping logical pairs, at least, advantageously improves the resource utilization in quantum processing.

According to an aspect of the invention, the provided computer-implemented method, computer system, and computer program product may further comprise initializing a magic state on each corner qubit in the subset of corner qubits and initializing the one or more stabilizer states on each non-corner qubit. In embodiments, the initializing a magic state on each corner qubit in the subset of corner qubits and initializing the one or more stabilizer states on each non-corner qubit, at least, advantageously improves the resource utilization in quantum processing.

According to an aspect of the invention, the provided computer-implemented method, computer system, and computer program product may further comprise the one or more stabilizer states are selected from the group consisting of: a |+> state and a |0> state. In embodiments, the one or more stabilizer states are selected from the group consisting of: a |+> state and a |0> state, at least, advantageously improves the resource utilization in quantum processing.

According to an aspect of the invention, the provided computer-implemented method, computer system, and computer program product may further comprise wherein the magic state is selected from the group consisting of a T state and a H state. In embodiments, wherein the magic state is selected from the group consisting of a T state and a H state, at least, advantageously improves the efficiency and utilization of a quantum computing system.

Quantum circuits that contain non-Clifford gates cannot be efficiently simulated on classical computers. The number of non-Clifford gates, which are generally comprised of magic states (e.g., |T> states), is often proportional to a computational advantage associated with a quantum algorithm over classical approaches, where a magic state is a quantum state that is prepared in advance and incorporated into fault-tolerant quantum computation in order to implement non-Clifford gates by combining the magic state with Clifford gates. In magic state distillation, many copies of lower-quality magic states (e.g., |T> states) are used as inputs into a distillation protocol to generate fewer but higher-quality magic states needed for applying non-Clifford operations. Magic state distillation is the leading method for implementing non-Clifford gates in fault-tolerant architectures, however, magic state distillation can be a major bottleneck, consuming a significant portion of quantum computer runtime.

Embodiments of the invention allow for a general procedure for organizing logical supports of quantum-error correcting (QEC) code by the parallel preparation of a plurality of magic states within a single QEC code block with a full round of stabilizer checks. Embodiments of the invention identify magic state initialization constraints for any code. Embodiments of the invention propose an inner loop comprising a greedy, iterative algorithm alternating between a plurality of X-logical and Z-logical supports. Embodiments of the invention propose an outer loop to minimize stabilizer states subject to desired constraints (e.g., specific to hardware connections or number of desired magic states). Embodiments of the invention utilize a mixture of magic state initialization and preparation in addition to fault-tolerant logical Pauli measurements. Embodiments of the invention parallelly prepare magic states (e.g., T states) allowing for fewer logical Clifford gates and fewer syndrome cycles, thus increasing computational efficiency of a quantum computational system. Embodiments of the present invention (e.g., magic state initialization circuit) prepare a plurality of magic states (e.g., 8 |T> states) at once, and require only one syndrome round without merged code (i.e., no ancilla system), with a reduced error rate (e.g., 10⁻⁷) compared to traditional injection-based approaches.

Implementation of embodiments of the invention may take a variety of forms, and exemplary implementation details are discussed subsequently with reference to the Figures.

The invention will now be described in detail with reference to the Figures.

FIG. 1 depicts computing environment 100 illustrating components of computer 101 in accordance with an illustrative embodiment of the invention. It should be appreciated that FIG. 1 provides only an illustration of one implementation and does not imply any limitations with regard to the environments in which different embodiments may be implemented. Many modifications to the depicted environment may be made.

Various aspects of the disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as magic state preparation program 150, hereinafter program 150. In addition to program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip”. In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in program 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

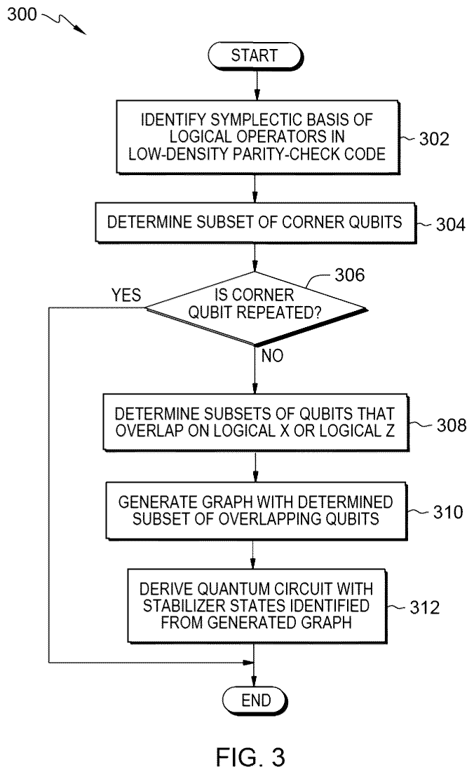

Program 150 is a program, a subprogram of a larger program, an application, a plurality of applications, or mobile application software, which functions to parallelly prepare magic states on quantum error correction codes. In various embodiments, program 150 may implement the following steps: determining a subset of corner qubits within a plurality of identified logical operators comprised within quantum error correction (QEC) code, wherein one or more corner qubits in the subset of corner qubits originate from an intersection of a first logical support and a second logical support; iterating through each qubit in the first logical support to determine a first set of qubits from the first logical support that overlap with a third logical support by iterating through each qubit in the first logical support; iterating through each qubit in the second logical support to determine a second set of qubits from the second logical support that overlap with a fourth logical support; generating a graph with the first set of qubits and the second set of qubits; identifying one or more stabilizer states utilizing the generated graph; and deriving a quantum circuit with the one or more stabilizer states and the subset of corner qubits. In the depicted embodiment, program 150 is a standalone software program. In another embodiment, the functionality of program 150, or any combination programs thereof, may be integrated into a single software program. In some embodiments, program 150 may be located on separate computing devices (not depicted) but can still communicate over WAN 102. In various embodiments, client versions of program 150 resides on any other computing device (not depicted) within computing environment 100. Program 150 is depicted and described in further detail with respect to FIG. 3.

References in the specification to “one embodiment”, “an embodiment”, “an example embodiment”, etc., indicate that the embodiment described may include a particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described.

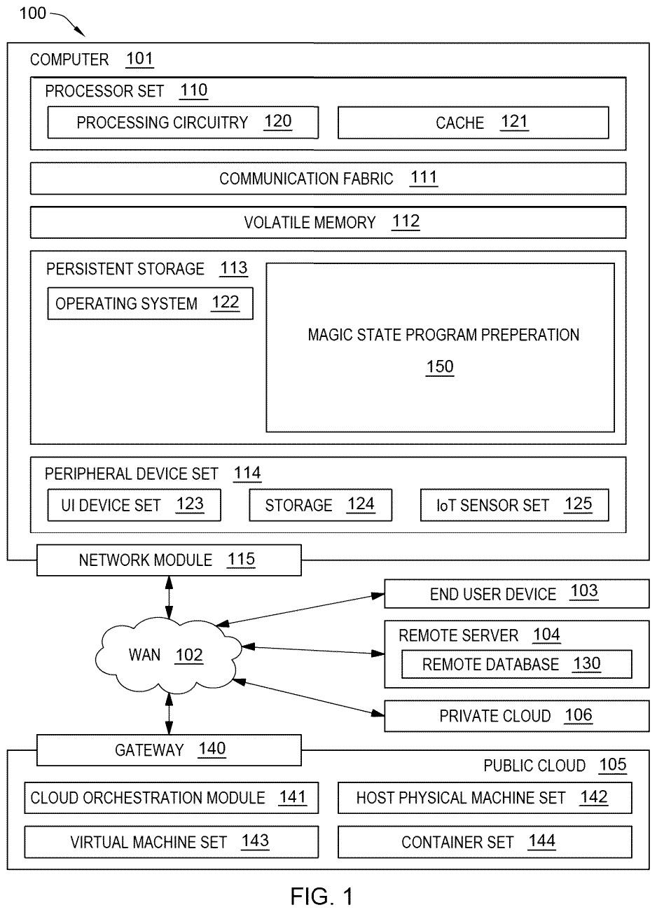

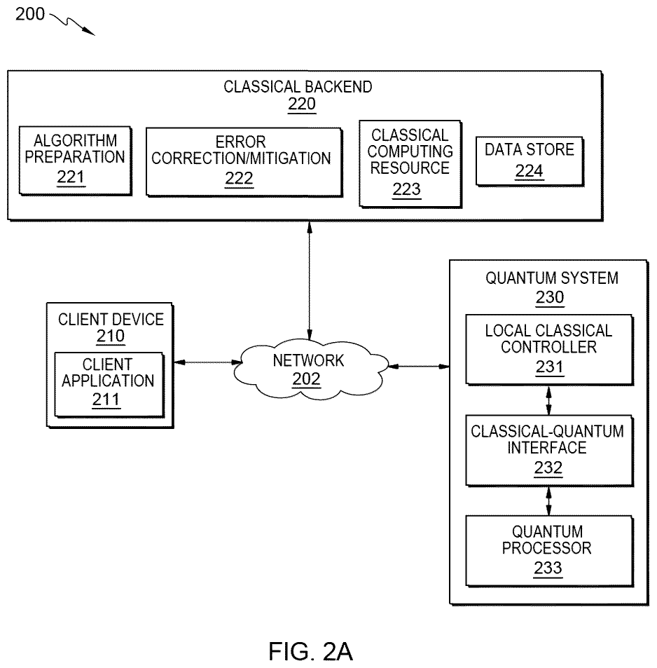

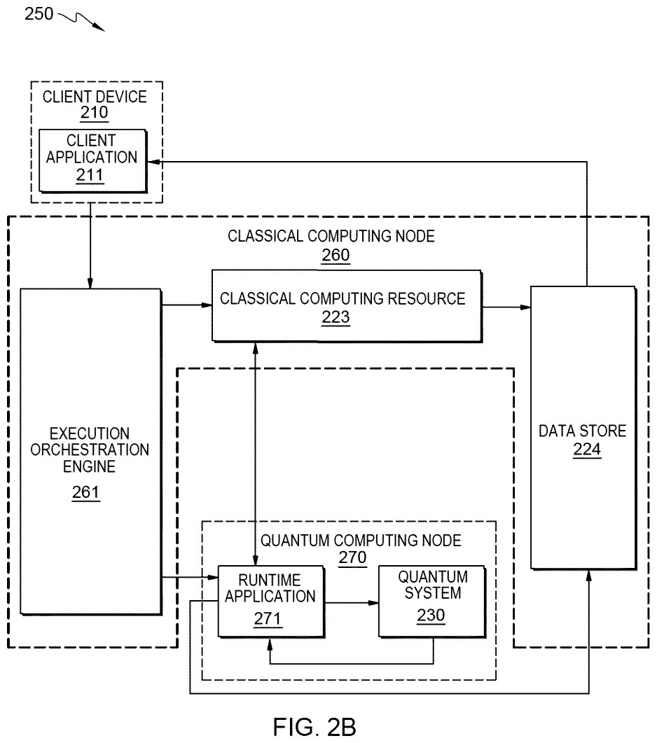

FIG. 2A illustrates a block diagram of an example hybrid computing system 200 that can facilitate execution of a quantum algorithm. As shown, a client device 210 may interface with a classical backend 220 to enable computations with the aid of a quantum system 230.

Network 202 may be any combination of connections and protocols that will support communications between the client device 210, the classical backend 220, and the quantum system 230. In an example embodiment, network 202 may WAN 102.

Client device 210 may be an implementation of computer 101 or EUD 103, described in more detail with reference to FIG. 1, configured to operate in a hybrid computing system 200.

Client application 211 may include an application or program code that includes computations requiring a quantum algorithm or quantum operation. In an embodiment, client application 211 may include an object-oriented programming language, such as Python® (“Python” is a registered trademark of the Python Software Foundation), capable of using programming libraries or modules containing quantum computing commands or algorithms, such as QISKIT (“QISKIT” is a registered trademark of the International Business Machines Corporation). In another embodiment, client application 211 may include machine level instructions for performing a quantum circuit, such as OpenQASM. Additionally, user application may be any other high-level interface, such as a graphical user interface, having the underlying object oriented and/or machine level code as described above.

The classical backend 220 may be an implementation of computer 101, described in more detail with reference to FIG. 1, having program modules configured to operate in a hybrid computing system 200. Such program modules for classical backend 220 may include algorithm preparation 221, classical computing resource 223, and data store 224.

Algorithm preparation 221 may be a program or module capable of preparing algorithms contained in client application 211 for operation on quantum system 230. Algorithm preparation 221 may be instantiated as part of a larger algorithm, such as a function call of an API, or by parsing a hybrid classical-quantum computation into aspects for quantum and classical calculation. Algorithm preparation 221 may additionally compile or transpile quantum circuits that were contained in client application 211 into an assembly language code for use by the local classical controller 231 to enable the quantum processor 233 to perform the logical operations of the circuit on physical structures. During transipilation/compilation an executable quantum circuit in the quantum assembly language may be created based on the calculations to be performed, the data to be analyzed, and the available quantum hardware. In one example embodiment, algorithm preparation 221 may select a quantum circuit from a library of circuits that have been designed for use in a particular problem. In another example embodiment, algorithm preparation 221 may receive a quantum circuit from the client application 211 and may perform transformations on the quantum circuit to make the circuit more efficient, or to fit the quantum circuit to available architecture of the quantum processor 233. Additionally, algorithm preparation 221 may prepare classical data from data store 224, or client application 211, as part of the assembly language code for implementing the quantum circuit by the local classical controller 231. Algorithm preparation 221 may additionally set the number of shots (i.e., one complete execution of a quantum circuit) for each circuit to achieve a robust result of the operation of the algorithm. Further, algorithm preparation 221 may update, or re-compile/re-transiple, the assembly language code based on parallel operations occurring in classical computing resource 223 or results received during execution of the quantum calculation on quantum system 230. Additionally, algorithm preparation 221 may determine the criterion for convergence of the quantum algorithm or hybrid algorithm.

Error Suppression/Mitigation 222 may be a program or module capable of performing error suppression or mitigation techniques for improving the reliability of results of quantum computations. Error suppression is the most basic level of error handling. Error suppression refers to techniques where knowledge about the undesirable effects of quantum hardware is used to introduce customization that can anticipate and avoid the potential impacts of those effects, such as modifying signals from Classical-quantum interface 232 based on the undesirable effects. Error mitigation uses the outputs of ensembles of circuits to reduce or eliminate the effect of noise in estimating expectation values. Error mitigation may include techniques such as Zero Noise Extrapolation (ZNE) and Probabilistic Error Correction (PEC).

Classical computing resource 223 may be a program or module capable of performing classical (e.g., binary, digital) calculations contained in client application 211. Classical calculations may include formal logical decisions, AI/ML algorithms, floating point operations, and/or simulation of Quantum operations.

Data store 224 may be a repository for data to be analyzed using a quantum computing algorithm, as well as the results of such analysis. Data store 224 may be an implementation of storage 124 and/or remote database 130, described in more detail with reference to FIG. 1, configured to operate in a hybrid computing system 200.

The quantum system 230 can be any suitable set of components capable of performing quantum operations on a physical system. In the example embodiment depicted in FIG. 2, quantum system 230 includes a local classical controller 231, a classical-quantum interface 232, and quantum processor 233. In some embodiments, all or part of each of the local classical controller 231, a classical-quantum interface 232, and quantum processor 233 may be located in a cryogenic environment to aid in the performance of the quantum operations. In an embodiment, classical backend 220 and quantum system 230 may be co-located to reduce the communication latency between the devices. Quantum system 230 may any combination of control qubit architectures to implement quantum computations, where logical qubits for logical operations can be single qubits or multiple qubits (e.g., a logical qubit as part of an error correcting code).

Local classical controller 231 may be any combination of classical computing components capable of aiding a quantum computation, such as executing a one or more quantum operations to form a quantum circuit, performing error-correction on logical qubits, or any other local classical computation, by providing commands to a classical-quantum interface 232 as to the type and order of signals to provide to the quantum processor 233. Local classical controller 231 may additionally perform other low/no latency functions, such as error correction, to enable efficient quantum computations. Such digital computing devices may include processors and memory for storing and executing quantum commands using classical-quantum interface 232. Additionally, such digital computing devices may include devices having communication protocols for receiving such commands and sending results of the performed quantum computations to classical backend 220. Additionally, the digital computing devices may include communications interfaces with the classical-quantum interface 232. In an embodiment, local classical controller 231 may include all components of computer 101, or alternatively may be individual components configured for specific quantum computing functionality, such as processor set 110, communication fabric 111, volatile memory 112, persistent storage 113, and network module 115.

Classical-quantum interface 232 may be any combination of devices capable of receiving command signals from local classical controller 231 and converting those signals into a format for performing quantum operations on the quantum processor 233. Such signals may include electrical (e.g., RF, microwave, DC), optical signals, magnetic signals, or vibrational signals to perform one or more single qubit operations (e.g., Pauli gate, Hadamard gate, Phase gate, Identity gate), signals to preform multi-qubit operations (e.g., CNOT-gate, CZ-gate, SWAP gate, Toffoli gate), qubit state readout signals, and any other signals that might enable quantum calculations, quantum error correction, and initiate the readout of a state of a qubit. Additionally, classical-quantum interface 232 may be capable of converting signals received from the quantum processor 233 into digital signals capable of processing and transmitting by local classical controller 231 and classical backend 220. Such signals may include qubit state readouts. Devices included in classical-quantum interface 232 may include, but are not limited to, digital-to-analog converters, analog-to-digital converters, waveform generators, attenuators, amplifiers, filters, optical fibers, and lasers.

Quantum processor 233 may be any hardware capable of using quantum states to process information. Such hardware may include a collection of qubits, mechanisms to couple/entangle the qubits, and any required signal routings to communicate between qubits or with classical-quantum interface 232 in order to process information using the quantum states. Such qubits may include, but are not limited to, charge qubits, flux qubits, phase qubits, spin qubits, and trapped ion qubits, or any other suitable qubit structures. The architecture of quantum processor 233, such as the arrangement of data qubits, error correcting qubits, and the couplings amongst them, may be a consideration in performing a quantum circuit on quantum processor 233.

Referring now to FIG. 2B, a block diagram is depicted showing an example architecture, and data transmission, of hybrid computation system 250 employed using a cloud architecture for classical backend 220. Hybrid computation system 250 receives an algorithm containing a computation from a client application 211 of client device 210. Upon receipt of the algorithm and request from client application 211, hybrid computation system 250 instantiates a classical computing node 260 and a quantum computing node 270 to manage the parallel computations. The classical computing node 260 may include one or more classical computers capable of working in tandem (e.g., utilizing the cloud computing environment described with reference to FIGS. 1 and 2A). For example, classical computing node 260 may include an execution orchestration engine 261, one or more classical computing resources 223, and a result data store 224. A backend quantum runtime system may include a combination of classical and quantum computing components acting together to perform quantum calculations on quantum hardware including, for example, one or more quantum systems 230. The quantum computing node 270 may include a quantum runtime application 271 and one or more quantum systems 230.

The client application 211 may include programing instructions to perform quantum and classical calculations. In an embodiment, client application 211 may be in a general purpose computing language, such as an object oriented computing language (e.g., Python®), that may include classical and quantum functions and function calls. This may enable developers to operate in environments they are comfortable with, thereby enabling a lower barrier of adoption for quantum computation.

The execution orchestration engine 261, in using algorithm preparation 221, may parse the client application 211 into a quantum logic/operations portion for implementation on a quantum computing node 270, and a classical logic/operations portion for implementation on a classical computing node 260 using a classical computing resource 223. In an embodiment, parsing the client application 211 may include performing one or more data processing steps prior to operating the quantum logic using the processed data. In an embodiment, parsing the client application 211 may including segmenting a quantum circuit into portions that are capable of being processed by quantum computing node 270, in which the partial results of each of the segmented quantum circuits may be recombined as a result to the quantum circuit. Execution orchestration engine 261 may parse the hybrid algorithm such that a portion of the algorithm is performed using classical computing resources 223 and a session of quantum computing node 270 may open to perform a portion of the algorithm. Quantum runtime application 271 may communicate, directly or indirectly, with classical computing resources 223 by sending parameters/information between the session to perform parallel calculations and generate/update instructions of quantum assembly language to operate quantum system 230, and receiving parameters/information/results from the session on the quantum system 230. Following the parsing of the hybrid algorithm for calculation on quantum computing node 270 and classical computing node 260, the parallel nodes may iterate the session to convergence by passing the results of quantum circuits, or partial quantum circuits, performed on quantum system 230 to classical computing resource 223 for further calculations. Additionally, quantum runtime application 271, using algorithm preparation 221, may re-parse aspects of the hybrid algorithm to improve convergence or accuracy of the result. Such operation results, and progress of convergence, may be sent back to client device 210 as the operations are being performed. By operating execution orchestration engine 261 in a cloud environment, the environment may scale (e.g., use additional computers to perform operations necessary) as required by the client application 211 without any input from the creators/implementors of client application 211. Additionally, execution orchestration engine 261, while parsing the client application 211 into classical and quantum operations, may generate parameters, function calls, or other mechanisms in which classical computation resource 223 and quantum computing node 270 may pass information (e.g., data, commands) between the components such that the performance of the computations enabled by client application 211 is efficient.

Classical computing resources 223 may perform classical computations (e.g., formal logical decisions, AI/ML algorithms, floating point operations, simulation of Quantum operations) that aid/enable/parallelize the computations instructed by client application 211. By utilizing classical computing resources 223 in an adaptively scalable environment, such as a cloud environment, the environment may scale (e.g., use additional computers to perform operations necessary including adding more classical computing resources 223, additional quantum systems 230, and/or additional resources of quantum systems 230 within a given quantum computing node 270) as required by the client application 211 without any input from the creators/implementors/developers of client application 211, and may appear seamless to any individual implementing client application 211 as there are no required programming instructions in client application 211 needed to adapt to the classical computing resources 223. Thus, for example, such scaling of quantum computing resources and classical computing resources may be provided as needed without user intervention. Scaling may reduce the idle time, and thus reduce capacity and management of computers in classical computing node 260.

Result data store 224 may store, and return to client device 210, states, configuration data, etc., as well as the results of the computations of the client application 211.

Implementation of the systems described herein may enable hybrid computing system 200, through the use of quantum system 230, to process information, or solve problems, in a manner not previously capable. The efficient parsing of the quantum or hybrid algorithm into classical and quantum segments for calculation may achieve efficient and accurate quantum calculations from the quantum system 230 for problems that are exponentially difficult to perform using classical backend 220. Additionally, the quantum assembly language created by classical backend 220 may enable quantum system 230 to use quantum states to perform calculations that are not classically efficient or accurate. Specifically, organizing logical supports of QEC code by the parallel preparation of magic states to reduce logical Clifford gates and syndrome cycles, thus increasing computational efficiency of a quantum computational system and reducing classical or quantum resource consumption. Such improvement may reduce the classical resources required to perform the calculation of the quantum or hybrid algorithm, by improving the capabilities of the quantum system 230.

FIG. 3 depicts flowchart 300 illustrating operational steps of program 150 for parallel preparation of magic states on quantum error correction codes, in accordance with an embodiment of the invention.

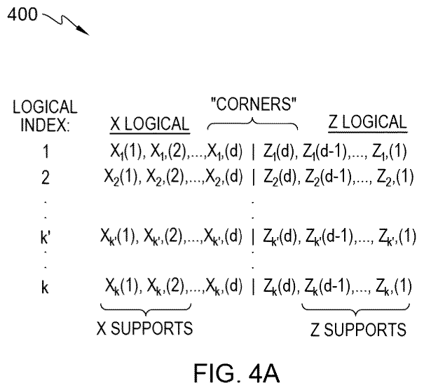

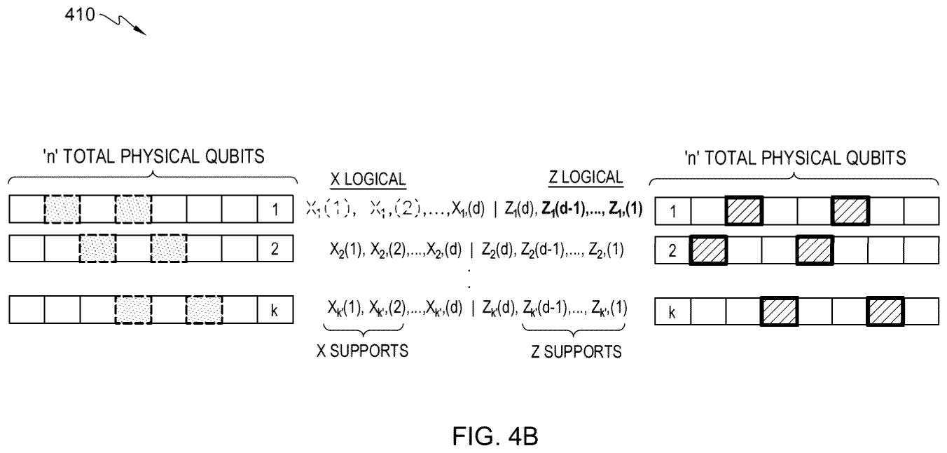

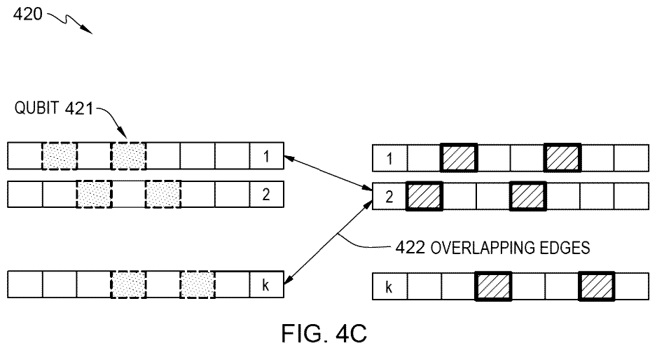

Program 150 identifies symplectic basis of logical operators in low-density parity-check code (step 302). Responsive to an inputted, generated, received, or inputted quantum error correction (QEC) code (e.g., low-density parity-check (LDPC) code (e.g., surface code, hypergraph product code)), program 150 initializes or begins the following procedures. In an embodiment, the LDPC code is a bivariate bicycle (BB) based on bivariate polynomial. In another embodiment, the BB code has parameters [[n, k, d]], where encodes k logical qubits into n data (i.e., physical) qubits offering a code distance d, and a logical error spans at least d data qubits. In an embodiment, program 150 considers k>1 logical qubits in preparing non-Clifford states on a subset of logical qubits (k′). In another embodiment, the stabilizer codes comprised in the LDPC code are Calderbank-Shor-Steane (CSS) type that can be described by a collection of qubit check (stabilizer) operators composed of Pauli X and Z. In another embodiment, the physical qubits of a BB code is expressed by a two-dimensional grid, with long-range connections, and periodic boundary conditions such that all check operators are obtained from a single pair of X and Z checks by applying horizontal, vertical, or long range shifts of the grid. In an embodiment, program 150 identifies all stabilizers within the LDPC code and, responsively, determines all logical operators of the quantum code from the identified stabilizers. In an embodiment, program 150 utilizes Gottesman's algorithm to transform each stabilizer into a standard form and then extracts the logical operators from the standard form. In an embodiment, program 150 identifies a symplectic basis of the logical operators through gaussian elimination and a greedy method (i.e., combinatorial optimization), as further described in FIG. 4A.

Program 150 determines a subset of corner qubits (step 304). In an embodiment, program 150 identifies one or more corner qubits (i.e., a logical support X (Xᵢ(d)) intersecting with a logical support Z (Zᵢ(d))) from the identified logical operators in step 302, wherein Xᵢ(d)=Zᵢ(d). In another embodiment, program 150 determines the subset of corner qubits as identified logical operators that have hyper-corners (i.e., a set of physical qubits supported in both logical bases (e.g., X and Z) and are anti-commuting in a code block). In an embodiment, program 150 checks or verifies whether each identified corner is repeated for all logical operators (i) within the subset of logical operators up to k′.

If a corner qubit is repeated (“yes” branch, decision block 306), then program 150 removes the repeated corner from the determined subset of corner logical qubits.

If a corner qubit is not repeated (“no” branch, decision block 306), then program 150 determines a subset of qubits that overlap on logical X supports or logical Z supports (step 308). In an embodiment, program 150 iterates over each qubit within each logical support (e.g., logical Z support or logical X support) in the determined subset of corner qubits, as described in step 304. For example, beginning from an identified corner, program 150 iterates through each qubit on a corresponding logical X support or logical Z support. Responsive to this iteration, program 150 determines whether a data qubit comprised within a logical Z support or logical X support overlaps with any other logical Z or logical X, where the overlapping logical is not one of the logical Z support or logical X support associated with the starting corner. For example, program 150 begins from a corner and iterates over a logical X support and records any qubits that overlap with a logical Z support that is not associated with the logical Z support of the corner. In an alternative example, program 150 may iterate over a logical Z support of the corner and record any data qubits overlapping on a logical X support that is not associated with the logical X support of the corner. In an embodiment, the procedure in step 308 is applied to each unique physical qubit for every logical X support and every logical Z support (i.e., non-corner qubits). In an embodiment, if an overlap is found, then program 150 records the connection between the X-logical qubit, Xᵢ(a), and the corresponding logical Z qubit, Zⱼ(b). In an embodiment, starting with Xᵢ(a), program 150 searches through each Z_{j≠i}(b) for all b≠d that equal Xᵢ(a). In an embodiment, this iterative, alternating algorithm is performed until the physical qubit Xᵢ(a) has been found on all logical operators, as identified in step 302. Step 308 results in an assignment of logical X and logical Z overlaps for every physical qubit, where {Xⱼ(i): Xₐ, X_{b}, . . . }, {Z_{c}, Z_{d}, . . . }, where a, b, c, d . . . ≠j for all j<=k′∧i, Zⱼ(i): {X_{a′}, X_{b′}, . . . }, {Z_{c′}, Z_{d′}, . . . }, where a′, b′, c′, d′ . . . ≠j for all j<=k′∧i.

Program 150 generates a graph with the determined subset of overlapping qubits (step 310). In an embodiment, program 150 generates a graph based on the determined subset of overlapping qubits, where the graph has nodes that are physical qubits, and edges if the nodes share overlapping logical pairs. In an embodiment, program 150 utilizes the generated graph to identify one or more stabilizer states based on a plurality of overlapping logical pairs. In another embodiment, program 150 utilizes the identified stabilizer states to impose additional stabilizer generators on one or more states if the one or more states commute with the identified stabilizer states. In another embodiment, program 150 determines a use for remaining stabilizers dependent on hardware constraints or implementation strategies (e.g., minimize connectivity constraints or correlated errors).

Program 150 derives a quantum circuit with stabilizer states identified from the generated graph (step 312). In an embodiment, program 150 prepares the identified stabilizer states, from step 310, and one or more magic states (e.g., T states (i.e., magic states that are defined as the eigenvectors of the e^{iπ/4}SH operator (i.e., an H gate followed by an S gate)), H states (i.e., Hadamard state)) for the identified corners from step 304. In an embodiment, for fault-tolerant preparation, program 150 performs d′ rounds of stabilizer projections. In further embodiment, program 150 initializes k′ logical qubits into magic states (e.g., |T> states). In another embodiment, for full fault-tolerance, program 150 prepares the identified stabilizer states utilizing projection rather than unitary operations. Responsively, program 150 derives a quantum circuit that is initialized (e.g., injected) with logical |T> states on each identified corner. In an embodiment, program 150 initializes every remaining non-corner qubit (i.e., qubit not initialized with a logical |T> state) with a stabilizer state (e.g., |+> state, |0> state). In another embodiment, responsive to the initialized states, program 150 validates the quantum circuit utilizing logical tomography or Gottesman-Knill simulation. In an embodiment, responsive to a failed verification, program 150 determines one or more alternative logical representatives such as stabilizers or automorphisms and repeats flowchart 300.

FIG. 4A depicts example illustration 400, in accordance with an illustrative embodiment of the invention. Example illustration 400 depicts a valid set of extracted logical operators (i.e., logical X and logical Z) with identified corner qubits for QEC code, as described in steps 302 and 304.

FIG. 4B depicts example illustration 410, in accordance with an illustrative embodiment of the invention. Example illustration 410 depicts the set of extracted logical supports from example illustration 400 with each logical operator represented as a hashed string of qubits, where non-corner supports are hashed.

FIG. 4C depicts example illustration 420, in accordance with an illustrative embodiment of the invention. Example illustration 420 contains qubit 421, a physical qubit within a first logical support (i.e., Xᵢ(a)) and overlapping edges 422, edges (e.g., arrows) containing information regarding one or more overlapping qubits between a first and second logical support. Example illustration 420 depicts the iterative, alternating algorithm of step 308, that program 150 performs until the physical qubit Xᵢ(a) has been found on all logical operators. The arrows are stored as a property of the physical qubit Xᵢ(a) within the generated graph of step 310 with n total nodes, one for each physical qubit.

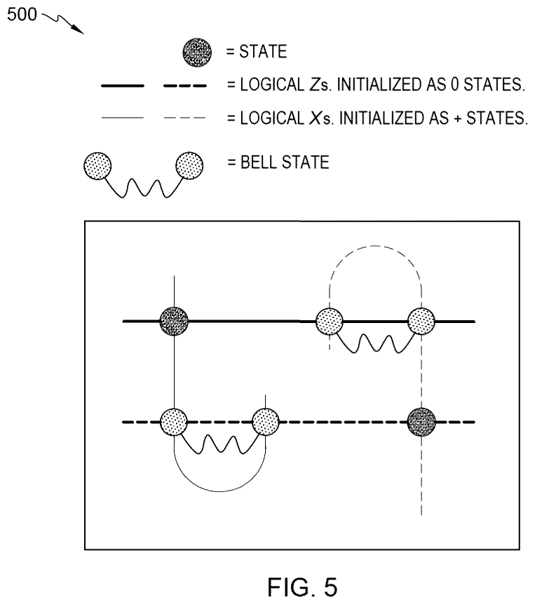

FIG. 5 depicts example illustration 500, in accordance with an illustrative embodiment of the invention. Example illustration 500 depicts a procedure detailed in flowchart 300, where program 150 encodes k T states by finding k pairs (X̅ᵢ, Z̅ᵢ), where X̅ᵢ is a qubit on a logical X (initialized as + states) and Z̅ᵢ (initialized as 0 is a qubit on a logical Z states), such that each pair X̅ᵢ and Z̅ᵢ overlap on just 1 qubit, the ith “corner”. In an embodiment, program 150 implements a bell state for each k pair.

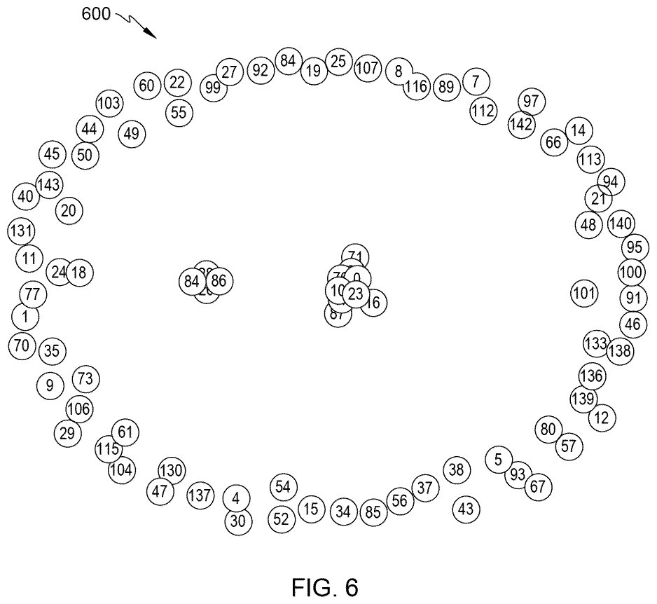

FIG. 6 depicts example graph 600, in accordance with an illustrative embodiment of the invention. Example graph 600 depicts a graph produced in step 310 by program 150, where the graph contains nodes that are physical qubits and edges if the nodes share overlapping logical pairs. Example graph 600 was generated for preparing 6 T states on a [[144,12,12]] code.

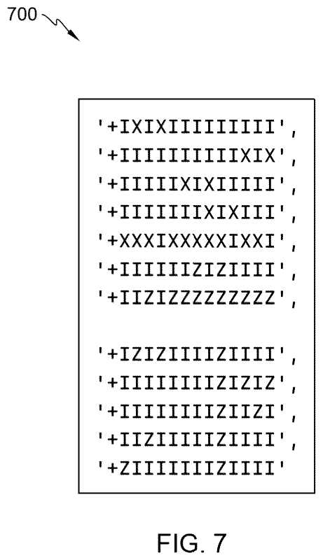

FIG. 7 depicts example illustration 700, in accordance with an illustrative embodiment of the invention. Example illustration 700 depicts a set of stabilizers as derived in step 312. Example illustration 700 demonstrates an example embodiment of the procedure detailed in flowchart 300, where program 150 has freedom to determine a use of remaining stabilizer (e.g., a set of 5 stabilizers for 13 qubits) depending on hardware constraints or implementation policies (i.e. minimize connectivity constraints or correlated errors).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
determining a subset of corner qubits within a plurality of identified logical operators comprised within quantum error correction (QEC) code, wherein one or more corner qubits in the subset of corner qubits originate from an intersection of a first logical support and a second logical support;
iterating through each qubit in the first logical support to determine a first set of qubits from the first logical support that overlap with a third logical support by iterating through each qubit in the first logical support;
iterating through each qubit in the second logical support to determine a second set of qubits from the second logical support that overlap with a fourth logical support;
generating a graph with the first set of qubits and the second set of qubits;
identifying one or more stabilizer states utilizing the generated graph; and
deriving a quantum circuit with the one or more stabilizer states and the subset of corner qubits.

2. The computer-implemented method of claim 1, wherein identifying the subset of corner qubits within the plurality of identified logical operators comprised within the QEC code, comprises:
removing repeated corner qubits.

3. The computer-implemented method of claim 1, wherein the QEC code is low-density parity-check code.

4. The computer-implemented method of claim 1, wherein the generated graph has nodes that are physical qubits and edges representing overlapping logical pairs.

5. The computer-implemented method of claim 2, wherein deriving the quantum circuit with the one or more identified stabilizer states and the determined subset of corner qubits, comprises:
initializing a magic state on each corner qubit in the subset of corner qubits; and
initializing the one or more stabilizer states on each non-corner qubit.

6. The computer-implemented method of claim 1, wherein the one or more stabilizer states are selected from the group consisting of: a |+> state and a |0> state.

7. The computer-implemented method of claim 5, wherein the magic state is selected from the group consisting of a T state and a H state.

8. A computer program product comprising:
one or more computer-readable storage media; and
program instructions stored on the one or more computer-readable storage media to perform operations comprising:
determining a subset of corner qubits within a plurality of identified logical operators comprised within quantum error correction (QEC) code, wherein one or more corner qubits in the subset of corner qubits originate from an intersection of a first logical support and a second logical support;
iterating through each qubit in the first logical support to determine a first set of qubits from the first logical support that overlap with a third logical support by iterating through each qubit in the first logical support;
iterating through each qubit in the second logical support to determine a second set of qubits from the second logical support that overlap with a fourth logical support;
generating a graph with the first set of qubits and the second set of qubits;
identifying one or more stabilizer states utilizing the generated graph; and
deriving a quantum circuit with the one or more stabilizer states and the subset of corner qubits.

9. The computer program product of claim 8, wherein identifying the subset of corner qubits within the plurality of identified logical operators comprised within the QEC code, comprises:
removing repeated corner qubits.

10. The computer program product of claim 8, wherein the QEC code is low-density parity-check code.

11. The computer program product of claim 8, wherein the generated graph has nodes that are physical qubits and edges representing overlapping logical pairs.

12. The computer program product of claim 9, wherein deriving the quantum circuit with the one or more identified stabilizer states and the determined subset of corner qubits, comprises:
initializing a magic state on each corner qubit in the subset of corner qubits; and
initializing the one or more stabilizer states on each non-corner qubit.

13. The computer program product of claim 8, wherein the one or more stabilizer states are selected from the group consisting of: a |+> state and a |0> state.

14. The computer program product of claim 12, wherein the magic state is selected from the group consisting of a T state and a H state.

15. A computer system comprising:
a processor set;
one or more computer-readable storage media; and
program instructions stored on the one or more computer-readable storage media to cause the processor set to perform operations comprising:
determining a subset of corner qubits within a plurality of identified logical operators comprised within quantum error correction (QEC) code, wherein one or more corner qubits in the subset of corner qubits from an intersection of a first logical support and a second logical support;
iterating through each qubit in the first logical support to determine a first set of qubits from the first logical support that overlap with a third logical support by iterating through each qubit in the first logical support;
iterating through each qubit in the second logical support to determine a second set of qubits from the second logical support that overlap with a fourth logical support;
generating a graph with the first set of qubits and the second set of qubits;
identifying one or more stabilizer states utilizing the generated graph; and
deriving a quantum circuit with the one or more stabilizer states and the subset of corner qubits.

16. The computer system of claim 15, wherein identifying the subset of corner qubits within the plurality of identified logical operators comprised within the QEC code, comprises:
removing repeated corner qubits.

17. The computer system of claim 15, wherein the QEC code is low-density parity-check code.

18. The computer system of claim 15, wherein deriving the quantum circuit with the one or more identified stabilizer states and the determined subset of corner qubits, comprises:
initializing a magic state on each corner qubit in the subset of corner qubits; and
initializing the one or more stabilizer states on each non-corner qubit.

19. The computer system of claim 15, wherein the one or more stabilizer states are selected from the group consisting of: a |+> state and a |0> state.

20. The computer system of claim 18, wherein the magic state is selected from the group consisting of a T state and a H state.
